(19) United States
(12) Patent Application Publication
(10) Pub. No.: US 2012/0145806 A1
(43) Pub. Date: Jun. 14, 2012

(54) APPARATUS AND METHOD FOR DISPENSING POWDERS

(75) Inventor: Shoufeng Yang, Winchester (GB)

(73) Assignee: Queen Mary & Westfield College, University of London, London (GB)

(21) Appl. No.: 13/390,478

(22) PCT Filed: Aug. 18, 2010
(86) PCT No.: PCT/EP2010/062058

§ 371 Date: Feb. 14, 2012

(30) Foreign Application Priority Data
Aug. 19, 2009 (GB) 0914507.9

(51) Int. Cl. B05B 1/08

(52) U.S. Cl. 239/102.1

(57) ABSTRACT

Apparatus for dispensing a powder, comprises a dispensing nozzle having an upper portion for containing a quantity of the powder, having a minimum internal horizontal dimension of 5 mm, and a dispensing orifice below the upper portion, with a maximum internal horizontal dimension of from 200 μm to 3 mm. An internal passage leading from the said upper portion to the dispensing orifice tapers in a linear manner from its upper end to its lower end. The apparatus includes a transducer for applying vibrational pulses to the dispensing nozzle, to dispense doses of powder from the orifice. Vibrational pulses are controlled to control flow of powder through the nozzle.

This invention relates to the dispensing of powders, and in particular to the dispensing of small but precise powder quantities. There are many situations in which powders must be weighed out or dispensed for routine analyses in small but precise quantities. For example, in many industrial and research settings, a chemist may be required to prepare dozens of samples daily either from a single stock powder or from various powder samples. In pre-clinical and Phase I/II clinical trials of drug development, samples may not be in the dose format of the final formulation, and an interim dose form is used to facilitate administration to both animals and humans. Weighing the required amount manually by skilled operators is generally regarded as being satisfactory for amounts of 20 mg or more. Another commercially important situation in which a need exists for the rapid and accurate dispensing of powders is for the industrial production of pharmaceutical products, for example powder-filled capsules, on a production line.

Laboratory dispensing stations exist in which powders are vacuum aspirated into a small vial which is then carried by robot to the destination. The tube is weighed by a built-in balance and this step is repeated until the expected mass is transferred. The devices have high capital cost, and the aspiration method is time consuming and tends to lose fine powders through the filter and to leave coarse powders in the source bottle.

Traditional metering and dispensing methods are generally slow and inaccurate when applied to the measurement of small quantities of dose mass. Weighing by hand by a skilled technician is generally satisfactory for dosage sizes of 20 mg to 200 mg. Other methods have also been developed using powder technology to enable lower mass doses to be dispensed, and to increase the accuracy of measurement.

Simple pneumatic powder dispensing devices are known, which are able to dispense powder with small dose masses of from 0.5 mg to 10 mg, but the accuracy is relatively low, because of the magnitude of the ejection pressure. Volumetric powder dispensing devices are also known. These can usually dispense powder with higher accuracy (less than 1% variation in dose mass deviation) and relatively high speed (3 to 11 g/s) but are very sensitive to any change of packing density, especially for “sticky” pharmaceutical powders. The so-called “Carr Index” is generally used as a measure of powder flowability. Powders with a Carr Index of greater than 25% are generally considered to be “sticky”. Electrostatic powder dispensing devices have been described that can eject doses as small as 0.3 mg with high accuracy and variation of dose mass of less than 6%.

Many of the most common type of device used for powder dispensing operate pneumatically. Pneumatic devices are able to provide on/off switch control. Metering and dispensing devices based on the pneumatic method is generally simple and therefore easily available for mass production. However, all of the above types of device are lacking in accuracy and reproducibility, especially for relatively “sticky” powders, of the type frequently used for formulating pharmaceuticals, such as starch and the like.

In recent years, vibratory devices have offered the promise of improved accuracy for certain types of powder dispensing operations. US-A-2004/0050860 and US-A-2004/0153262 disclose devices for dispensing dry powders, in which the powder is contained in a conical hopper, and dispensed by means of a mechanical valve. Vibration energy, generated using a piezoelectric layer on the surface of the hopper, is used in order to assist movement of the material in the hopper.

The method requires a mechanical valve to close and open the hopper outlet, and is prone to blockage. It is also not well adapted to dispensing powders that are somewhat “sticky”, such as starch-based materials, that are frequently used in the preparation of pharmaceuticals.

A number of publications also describe methods for dispensing powders by the use of vibrational pulses, without the need for a mechanical closure valve. Examples of such publications are the following:—
S. Yang and J. R. G. Evans. A dry powder jet printer for dispensing and combinatorial research, Powder Technology 142 (2004), 2-3, 219-222.
X. Lu, S. Yang, J. R. G. Evans. Studies on ultrasonic microfeeding of fine powders, Journal of physics D: Applied physics, 39 (11): 2444-2453 2006 DOI: 10.1088/0022-3727/39/11/020
X. Lu, S. Yang, L. Chen and J. R. G. Evans, Dry powder microfeeding system for solid freeform fabrication. The Seventeenth Solid Freeform Fabrication Symposium, Austin, Tex., USA. Aug. 14-16, 2006.
X. Lu, S. Yang, J. R. G. Evans. Dose uniformity of fine powders in ultrasonic microfeeding, Powder Technology, 175 (2) 2007, 63-72. doi:10.1016/j.powtec.2007.01.029
S. Yang and J. R. G. Evans. Metering and dispensing of powder; the quest for new solid freeforming techniques. Powder Technology. 178 (1) 2007, 56-72. doi: 10.1016/j.powtec.2007.04.004.
X. Lu, S. Yang, J. R. G. Evans. Ultrasound-Assisted Microfeeding of Fine Powders, Particuology 6 (1) 2-8, 2008, DOI:10.1016/j.cpart.2007.10.007.
X. Lu, S. Yang, J. R. G. Evans. Microfeeding with different ultrasonic nozzle designs, Ultrasonics. http://dx.doi.org/10.1016/j.ultras.2009.01.003 2009
Matsusaka et al. Microfeeding of a fine powder using a vibrating capillary tube, Adv. Powder Technol. 7 (1996) 141-151
Y. Yang, X. Li, Experimental and analytical study of ultrasonic micro powder feeding, J. Phys., D, Appl. Phys. 36 (2003) 1349-1354.
Saito et al. A quantitative powder supply method using ultrasonic vibration. J. Jpn Acoust. Soc 45 (1989) 38-43
Yahchuck et al. Production of dry powder clots using a piezoelectric drog generation. Rev. Sci. Instrum 73 (2002) 2331 2335.

Although these methods have shown considerable promise for dispensing small powder amounts, we have found that dispensing is frequently inconsistent, because of a tendency of the powder column in the dispensing hopper to break, and/or the formation of “domes” within the dispensing capillary. Such difficulties are particularly acute in the dispensing of certain powder types, especially powders with a one or more of the following properties:—

(i) small particle size (for example, less than 50 μm, particularly less than 20 μm),
(ii) low bulk density (for example, less than 2,000 kg/m³, particularly less than 1,000 kg/m³, more particularly less than 500 kg/m³),
(iii) a high angle of repose (for example, at least 30°, more particularly at least 40°).
The angle of repose of a granular material can be determined by pouring the material onto a horizontal surface to form a conical pile, and measuring the angle formed between the surface of the conical pile of material, and the horizontal.
There are a number of methods for measuring particle size, which give generally comparable results. For the avoidance of doubt however, in case of ambiguity, the term “particle size” as used herein is intended to refer to measurements made according to ASTM B822-02.

Powders which display the properties described above, in particular two or more such properties, are generally found to be “sticky” (i.e. to have poor flowability). Many powders used in the formulation of pharmaceuticals satisfy the above criteria. Although some of the vibrational dispensing methods discussed above are successful with non-sticky powders (for example metal powders, which have a density of more than 2,000 kg/m³), they are far less successful with “sticky” powders.

US-A-2007/0104864 discloses a method for vaporising particulate material and depositing it on a surface to form a layer. A supply hopper is used to supply the powder material.

SU-A-595629 describes a powder dispenser in which a vibrated hopper dispenses powder onto a rotating disc. The powder is sucked through the nozzle by a pump.

US-A-2007/193646 describes a powder-fluidising apparatus for feeding ultra fine and nano-sized powders. The powder is brushed through holes in a removable sieve plate, which breaks up a agglomerated particles in the powder and controls the powder feed rate. The funnel surface is continuously vibrated to avoid powder build up on the surface.

EP-A-0282958 describes a device for feeding powders by applying mechanical vibrations directly or indirectly to the powder and thereby driving it through a nozzle. The frequency of the vibrations is preferably made equal to the natural resonance of the particles.

WO-A-2008/003942 describes a powder dispensing system utilising a complex nozzle structure for delivering a powdered metal to a laser beam for spot wielding.

None of the methods described above are capable of accurately dispensing doses of a powder, in rapid succession, and with high dose accuracy.

We have now developed an improved dispenser from which powders can be dispensed simply by the use of a vibrational pulse, without the need for a mechanical closure valve, and which shows a significantly reduced tendency to stoppages due to dome formation and breakage of the powder column, by the use of a specific range of constructional dimensions for the dispenser and associated orifice.

According to the invention, there is provided apparatus for dispensing a powder, comprising:—

a dispensing nozzle having an upper portion for containing a quantity of the powder, the upper portion having a minimum internal horizontal dimension of 5 mm,
a dispensing orifice for dispensing the powder, the dispensing orifice being disposed below the upper portion, wherein the dispensing orifice has a maximum internal horizontal dimension of from 200 μm to 3 mm, and
an internal passage leading from the said upper portion to the dispensing orifice, wherein the internal passage has an upper end connected to the said upper portion, and a lower end,
communicating with the said orifice, and wherein the said internal passage tapers in a linear manner from its said upper end to its said lower end,
wherein the apparatus also includes a transducer for applying vibrational pulses to the dispensing nozzle, to dispense a dose of powder from the orifice,
and means for controlling said vibrational pulses to thereby control flow of powder through the nozzle. Preferably, the dispensing nozzle is permanently open during the dispensing process, and the flow of powder through the nozzle is controlled only by the said vibrational pulse.

According to our investigations, the use of a dispensing orifice with a maximum internal dimensional of 3 mm, in combination with the use of a continuously tapering internal passage from the upper portion of the body of the dispensing apparatus to the dispensing orifice enables powders, and in particular powders otherwise difficult to dispense, to be delivered from the nozzle by the use of a vibrational pulse alone, without the need for a control valve to open or close the orifice, and with a reduced tendency to flow stoppage, as compared with the prior art methods previously discussed. The taper angle of the walls of the internal passage can play an important part in ensuring the free flowing of the powder through the apparatus without blocking. It is particularly preferred that the walls of the internal passage taper at an angle of from 5° to 45° to the vertical, more preferably from 10° to 30° to the vertical.

The maximum size (i.e. the maximum internal horizontal dimension) of the dispensing orifice is 3 mm, preferably 2 mm, more preferably 1 mm. The term “the maximum internal horizontal dimension” is used herein since there is no strict requirement that the dispensing orifice should be circular, and other configurations (for example elliptical) are theoretically possible. In most cases however, the orifice will be circular in cross section, in which case, the term “maximum internal horizontal dimension” refers to the internal diameter of the orifice.

The upper portion of the body of the apparatus essentially forms a container for the bulk of the powder to be dispensed. Like the dispensing orifice, the upper portion will generally be circular in cross section. Although there is no maximum size for the upper portion, its minimum internal horizontal dimension (usually, its internal diameter) is at least 5 mm, and preferably at least 7 mm.

The dispensing device in accordance with the invention is capable of providing controlled release, “drop-on-demand” dispensing. The powder flow is controlled using a train of ultrasonic pulses, so that the device behaves like a valve and yet has no mechanical closure. When a wave pulse is sent, the behaviour is like a valve opening, and the powder flows. When the wave is switched off, the valve effectively closes, and powder flow stops. By the choice of an appropriate ultrasonic pulse waveform, accurate dispensing of known doses of a wide range of desired magnitude can be achieved.

The amount of powder dispensed by an individual pulse is influenced by a number of factors, for example nozzle diameter, waveform, voltage amplitude, frequency, and duration of pulses in the pulse train, as well as the strength of cohesive forces within the powder. The preferred method of controlling dose size is by control of the voltage amplitude and duration of pulses in the ultrasound pulse train.

To this end, means for controlling the vibrational pulses may include an electrical pulse train generator connected to the transducer, adapted to produce a train of electrical pulses, wherein each said electrical pulse is such as to cause the transducer to dispense a predetermined quantity of the said powder. The electrical pulses may be substantially identical, whereby each predetermined quantity of powder is substantially equal.

The method of the invention is particularly suitable for the dispensing of powers with one or more of the following properties:—

(i) small particle size (for example, less than 50 μm, particularly less than 20 μm),
(ii) low bulk density (for example, less than 2,000 kg/m³, particularly less than 1,000 kg/m³, more particularly less than 500 kg/m³)
(iii) a high angle of repose (for example, at least 30°, more particularly at least 40°).
It is to be noted however that the method is also useful for powders with larger particle sizes, for example those with a particle size in the range 50 to 500 μm, particularly 200 μm or more.

The method of the invention may be employed in many technical areas in which the accurate dispensing of powders is needed, for example, combinatorial research, in custom formulation of pharmaceuticals for research purposes and in the production-line dispensing of pharmaceutical formulations into vials or blisters. Further applications arise in smart card technology, where the technique may be used to dispense an embossed ID marker on individual smart cards, with varied materials composition or colour, to prevent card fraud. Other areas of application are in advanced stereolithography, 3D and multilayer printing, laminated object manufacture, mixing of pigments for paints, inks and glazes, selective laser sintering, direct dry powder ink-jet printing, and applications requiring precise placement of powder samples e.g. in the alveolar delivery of medicine, and nanoparticle synthesis in spray pyrolysis.

A preferred embodiment of the invention will now be illustrated with reference of the accompanying drawings, in which:—

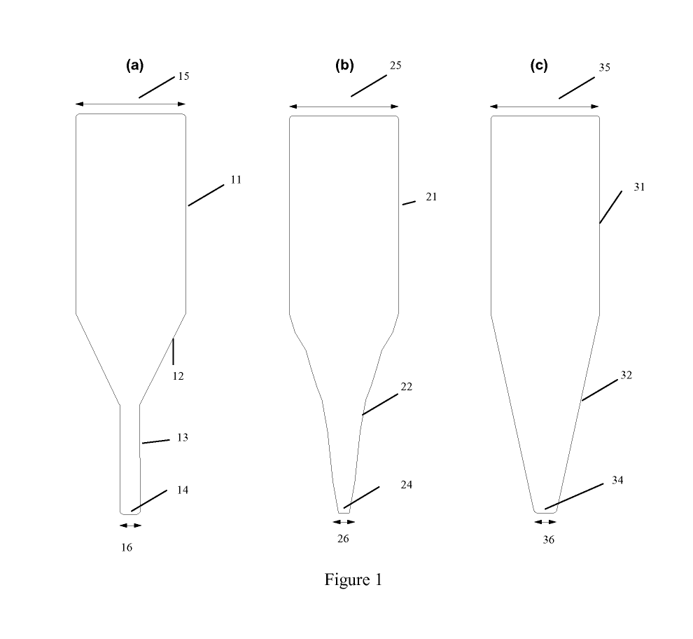

FIG. 1a is a schematic diagram of a standard glass dispensing pipette;

FIG. 1b is a schematic diagram of a hand-blown tapering pipette, not in accordance with the invention, of which the internal passage has a cross section that decreases in a non-continuous manner;

FIG. 1c is a schematic diagram of a dispensing apparatus in accordance with the invention;

FIG. 2 is a schematic diagram showing the incorporation of a dispensing apparatus of the general kind shown in FIG. 1c in an ultrasonic dispensing apparatus

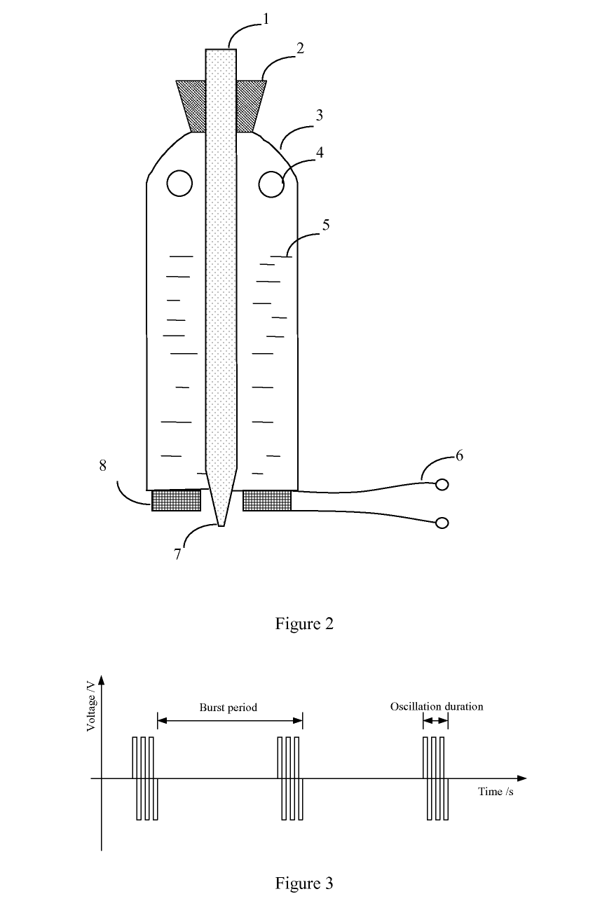

FIG. 3 is an illustration of an ultrasonic waveform suitable for use in the dispensing method;

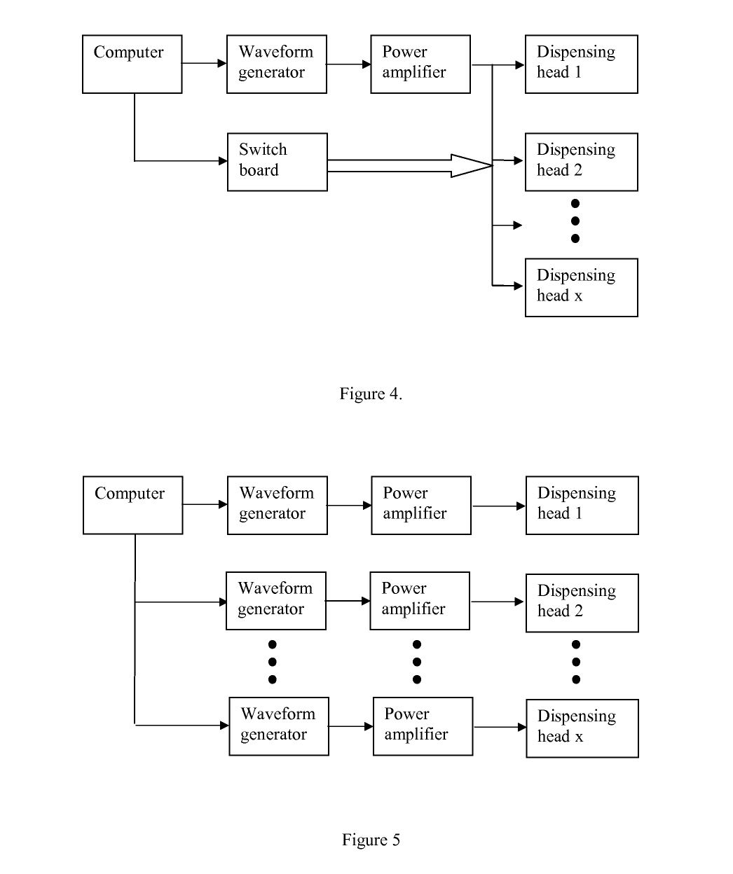

FIGS. 4 and 5 are schematic diagrams of suitable control arrangements for devices in accordance with the invention, and

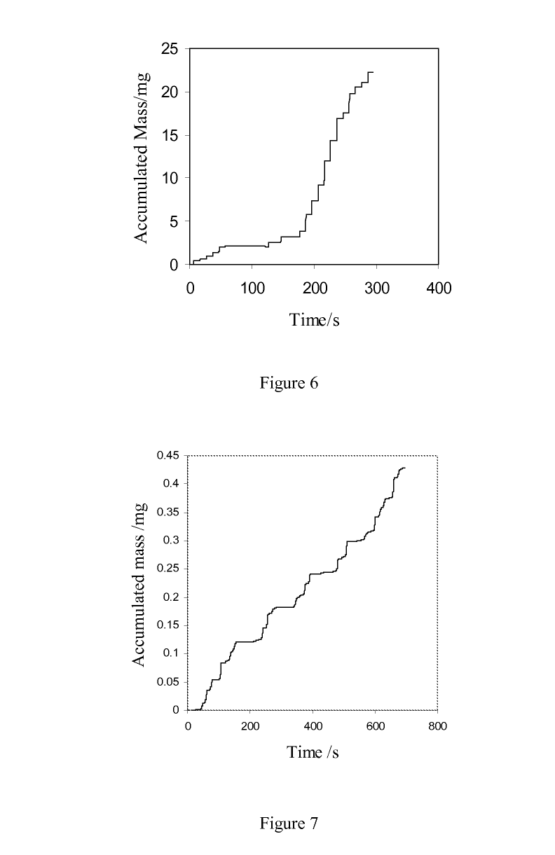

FIG. 6 shows a dispensing curve obtained using the nozzle of FIG. 1a

FIG. 7 shows a dispensing curve obtained using the nozzle of FIG. 1b;

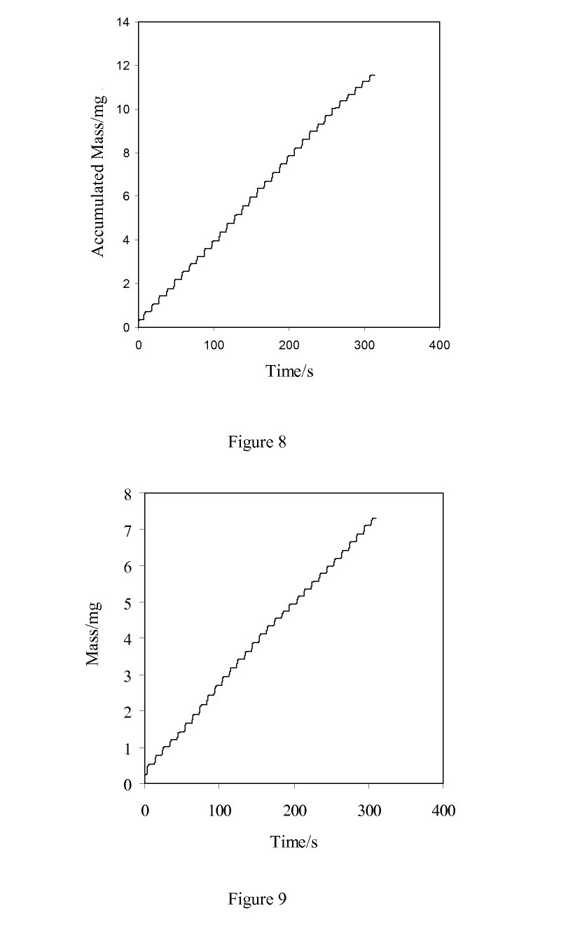

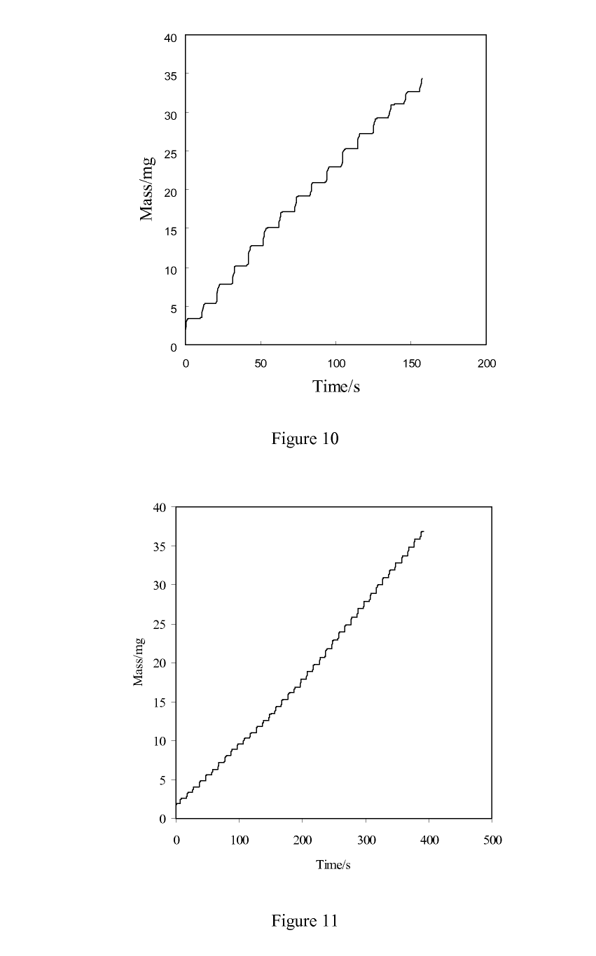

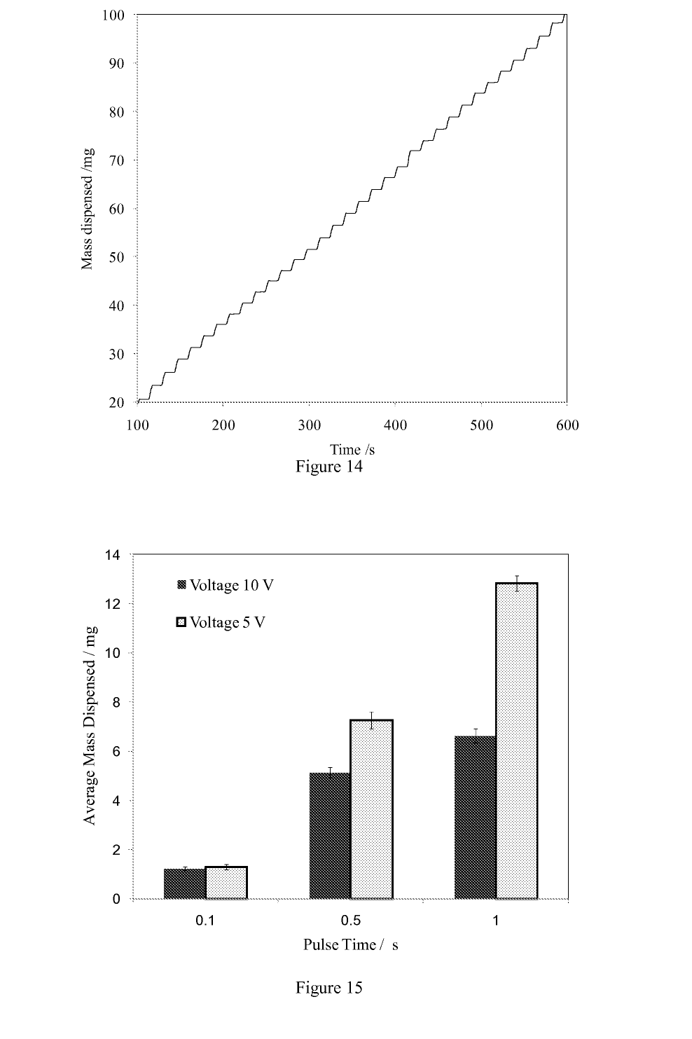

FIGS. 8 to 14 show dispensing curves obtained for various powders, obtained using apparatus in accordance with the invention (incorporating the nozzle of FIG. 1c); and

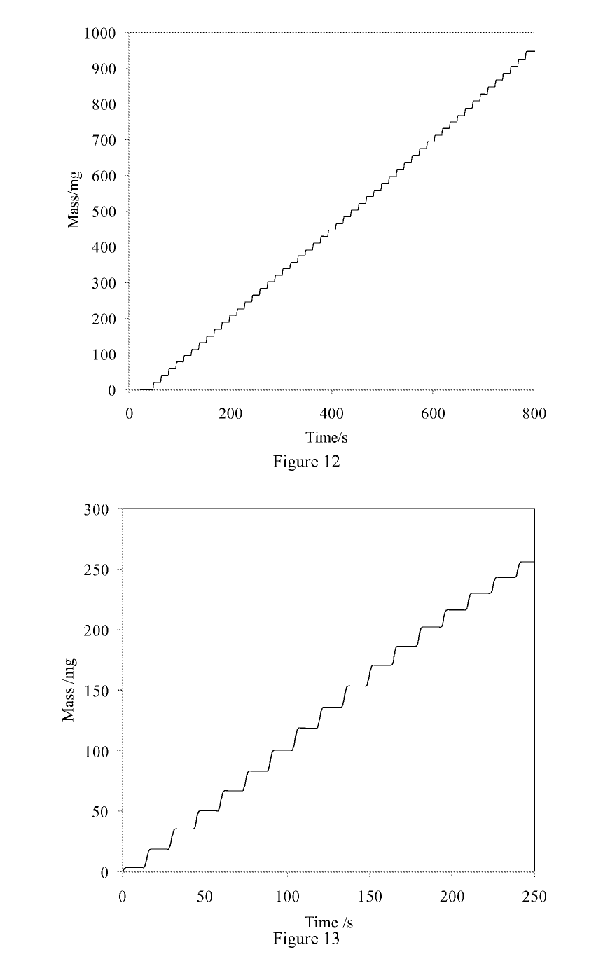

FIG. 15 shows the variation of mass dispensed, with pulse time, for the powder of FIG. 12.

The apparatus of FIG. 2 includes an outer vessel 3, containing a nozzle 1, supported at its upper end by a rubber stopper 2. Vessel 3 is substantially filled with water 5, to transmit ultrasonic vibration from a piezoelectric transducer 8, affixed to the lower part of the vessel. Water 5 serves as an effective transmitter of ultrasonic pulses from piezoelectric transducer 8 to nozzle 1.

The lower end of nozzle 1 protrudes through an opening in the lower end of vessel 3, which is sealed to prevent egress of water. The lower end of nozzle 1 terminates in a nozzle orifice 7, and electrical leads 6 provide power to piezoelectric transducer 8.

Nozzle 1 of FIG. 2 is of the general form shown schematically in FIG. 1c, which will be described in more detail hereafter. Also illustrated, in FIGS. 1a and 1b are alternative nozzle configurations (not in accordance with the invention).

For purposes of comparison, FIG. 1a illustrates schematically a standard glass pipette consists of three main parts, an upper columnar zone 11, a tapered zone 12, and a lower parallel tube zone 13. The pipette of FIG. 1b is somewhat similar to that of FIG. 1a but has no separate lower parallel tube zone. Instead it has a non-uniform tapered section 22 with an internal diameter that decreases in a non-uniform way over its length from 7 mm at its upper end to 0.7 mm at its lower end.

The device in accordance with the invention, in accordance with FIG. 1c has an upper columnar section 31, and a tapered section 32 with an internal diameter that decreases continuously in size from an internal diameter of 8 mm at its upper end 35, to 0.5 mm at orifice 34 at its lower end. The internal walls of the tapered zone 32 are at an angle of approximately 20 degrees to the vertical. The internal surface of the wall of section 32 tapers in a linear fashion from its upper end to its lower end, thereby presenting a smooth surface for the flow of powder through the nozzle.

The tapered section 32 terminates directly at dispensing orifice 34, without any intermediate parallel-walled section of the kind represented by section 13 in the nozzle of FIG. 1a.

A computer can be used to control ultrasonic bursts applied to the piezoelectric transducer 8, in accordance with the schematic diagrams shown in FIGS. 4 and 5. As shown in FIG. 4 or FIG. 5, a number of dispensing heads can be provided, depending on the application.

### EXAMPLES 1 TO 4 AND COMPARATIVE EXAMPLES 1A & 1B

Nozzle 1 is filled with a suitable powder, as shown in FIG. 2, and piezoelectric transducer 8 is connected to an appropriate control circuit (for example as shown in FIG. 4 or FIG. 5) by means of leads 6. A waveform of the general type shown in FIG. 3 can be applied. Very effective control can be achieved using ultrasonic frequencies in the range 20 to 60 kHz, for example 40 to 45 kHz. Low voltage transducers, for example operating at an applied voltage of 6 volts have been found satisfactory.

The oscillation period (as shown in FIG. 3) can be used to control the dosage of powder dispensed in each dose. With the apparatus described, typical oscillation periods are from approximately 0.01-10 seconds, more usually, from 0.1 to 1 second. The burst period (as shown in FIG. 3) controls the time between dispensation of each dose, and the time interval chosen will therefore depend on the particular application, for example the geometry of the production or other environment in which the device is operated.

The performance of nozzle shapes illustrated in FIGS. 1a 1b and 1c and FIG. 2 were compared, using lactose monohydrate, which is typical of powders used in the pharmaceutical industry, with low bulk density, small particle size, and high angle of repose, which is difficult to dispense by existing methods. The results are shown in Table 1. The apparatus used was as shown in FIG. 2, with a nozzle generally as illustrated in FIG. 1c. An ultrasound pulse train with pulses of duration 0.5 seconds, was applied by means of ultrasonic transducer 8. The nozzle size (36), frequency of ultrasound pulses applied, and voltage utilised are as shown in Table 1. The accumulated amount of powder dispensed was measured, using an electronic microbalance. A gap of 10 seconds was allowed between each dispensing pulse to allow the balance to settle. The dispensing curves obtained are shown in FIGS. 6 to 8. The regular square wave “ladder” curve of FIG. 8 demonstrates that powder is dispensed in accurate and reproducible aliquots, during ultrasonic pulses, but not between pulses, using the nozzle of FIG. 1c. The shape of FIGS. 6 and 7 both show erratic and unreliable dispensing, using the nozzle of FIGS. 1a and 1b.

TABLE 1

| Example No | Comp. 1a | Comp. 1b | 1 | 2 | 3 | 4 |
|---|---|---|---|---|---|---|
| Material | Lactose | Lactose | Lactose | Polyvinyl | Starch ⁽³⁾ | lactose ⁽⁴⁾ |
| | Monohydrate ⁽¹⁾ | Monohydrate ⁽¹⁾ | Monohydrate ⁽¹⁾ | Butyral ⁽²⁾ | | |
| Nozzle | 1a | 1b | 1c | 1c | 1c | 1c |
| Figure No | 6 | 7 | 8 | 9 | 10 | 11 |
| Bulk density ⁽⁶⁾ | 320-360 | 320-360 | 320-360 | 300-350 | 500-700 | 460-760 |
| kg · m⁻³ | | | | | | |
| Particle size range | 1-100 | 1-100 | 1-100 | 12-40 | 6-26 | 20-71 |
| (μm) | | | | | | |
| Estimated angle | >45° | >45° | >45° | Unknown | 49° | <30° |
| of repose ⁽⁵⁾ | | | | | | |
| Nozzle Size (mm) | 0.6 | 0.6 | 0.6 | 0.5 | 0.5 | 0.5 |
| Voltage | 4 | 4 | 4 | 8 | 5 | 5 |
| f(Hz) | 44,250 | 44,250 | 44,250 | 42,280 | 42,520 | 44,250 |

⁽¹⁾ V W R International, Belgium
⁽²⁾ WACKER, Germany (Pioloform ™)
⁽³⁾ KGaA MERCK, Germany
⁽⁴⁾ Spray dried - Huxley Betram Ltd. UK
⁽⁵⁾ from earlier published data (Angle of repose was measured approximately, by pouring the material to form a heap, photographing the resulting heap, and measuring the repose angle in the resulting photograph - average of 5 measurements)
⁽⁶⁾ information provided by the manufacturers.

The experiment of FIG. 8 was repeated, using three other powders used which are difficult to dispense by existing methods. The results are shown in Table 1 (Examples 2, 3, and 4) and in FIGS. 9 to 11. In each case, a regular square wave “ladder” curve was obtained, demonstrating that powder is dispensed in accurate and reproducible aliquots. In all cases, the powders are self-supporting in the nozzle 1 when no ultrasonic power is applied but are dispensed consistently and reproducibly whilst ultrasonic power is applied. It can clearly be seen from FIGS. 6, 7, and 8 that dose accuracy and reproducibility are significantly diminished, for the nozzles of FIGS. 1a and 1b, as compared with the nozzle of FIG. 1c. It is believed that the unsatisfactory results of the nozzles of FIG. 1a and 1b are caused by blocking of the powder in the lower parallel section 13 of nozzle 1b, by the breaking up of the column of powder in section 13, and by it breaking apart from the body of powder in the main body section 11, and by the formation of domes in the powder structure, that prevent the powder dose discharging reliably from the nozzle tip.

Although the nozzle of FIG. 1b gives somewhat improved results as compared with that of 1a, the non-uniform nature of the tapered section 22 of nozzle 1b also causes blocking in the powder flow through the nozzle when “difficult” powders are dispensed.

By the choice of the specific values for the maximum internal nozzle diameter, the minimum diameter of upper section 31, and the use of a smoothly tapering internal passage from the upper portion directly to the dispensing nozzle, with no intervening parallel section, greatly improved dose dispensation can be achieved.

It is noteworthy that even though nozzles in FIG. 1a and FIG. 1b have an orifice diameter somewhat larger than that of the nozzle in FIG. 1c their tendency to block is significantly greater than that of the nozzle FIG. 1c.

### EXAMPLES 5 TO 7

The method of Example 1 was repeated for three powders commonly used in pharmaceutical manufacture, namely two grades of α-Lactose Monohydrate (InhaLac® 70 and SpheroLac® 100) and a Microcrystalline Cellulose (Avicel® PH-102). Particle size range and angle of repose are based on figures provided by the manufacturers. The properties are given in Table 2.

Each powder was dispensed by the same method as described in Example 1, using nozzle diameters as shown in Table 2.

TABLE 2

| Example No | 5 | 6 | 7 |
|---|---|---|---|
| Material | α-Lactose | α-Lactose | Microcrystalline |
| | Monohydrate | Monohydrate | Cellulose |
| Grade | InhaLac ® 70 | SpheroLac ® 100 | Avicel ® PH-102 |
| Manufacturer | Meggle GmbH | Meggle GmbH | FMC Biopolymer |
| Nozzle | 1c | 1c | 1c |
| Figure No | 12 | 13 | 14 |
| Bulk density (6) | 590-660 | 685-840 | 280-330 |
| kg · m−3 | | | |
| Particle size, | 110-300 | 50-250 | 30-260 |
| range (μm) | | | |
| Estimated angle | 31.3 | 38 | 42 |
| of repose (5) | | | |
| Pulse Time (sec) | 0.5 | 1.0 | 1.0 |
| Nozzle Size (mm) | 0.9 | 0.7 | 0.7 |

The ultrasonic frequency was fixed at 44,800 Hz with a square wave waveform at an amplitude of 10 V.

A period of 6 seconds was allowed between each dispensing pulse, to allow the balance to settle. The resulting dispensing curves are shown in FIGS. 12 to 14.

In each case, a regular square wave “ladder” curve was obtained, demonstrating that powder is dispensed in accurate and reproducible aliquots.

In all cases, the powders are self-supporting in the nozzle 1 when no ultrasonic power is applied but are dispensed consistently and reproducibly whilst ultrasonic power is applied.

FIG. 15 shows the effect of pulse length on the amount of powder dispensed, using the powder of Example 5 (InhaLac® 70), dispensed using 0.7 mm nozzle size, at varying pulse times, (0.1 to 1.0 second) with two different voltages (5 V and 10 V) and at a fixed frequency 44,800 Hz. It can be seem that for an applied voltage of 5V, the mass dispensed is directly proportional to the pulse length. For an applied voltage of 10V, the mass dispensed is no longer directly proportional to pulse length, but it is nonetheless reproducible from pulse to pulse, so that known aliquots can easily be dispensed reliably, by pre-calibration, and the use of a suitable calibration curve. Ultrasonic pulses having a length of from 0.01 to 2 seconds have been found to result in the dispensing of a reproducible and fixed masses of powder of from 0.25 mg to 40 mg.

The device in accordance with the invention provides significant advantages of increased speed and reduced complexity in comparison with currently available systems for rapidly and reproducibly dispensing doses of pharmaceutical powders. They are readily adapted to scale-up for production-line applications, and provide controllable, repeatable doses without the need for weighing.

1. Apparatus for dispensing a powder, comprising:
a dispensing nozzle having an upper portion for containing a quantity of the powder, the upper portion having a minimum internal horizontal dimension of 5 mm,
a dispensing orifice for dispensing the powder, the dispensing orifice being disposed below the upper portion, wherein the dispensing orifice has a maximum internal horizontal dimension of from 200 μm to 3 mm, and
an internal passage leading from the said upper portion to the dispensing orifice, wherein the internal passage has an upper end connected to the said upper portion, and a lower end, communicating with the said orifice, and wherein the said internal passage tapers in a linear manner from its said upper end to its said lower end,
wherein the apparatus also includes a transducer for applying vibrational pulses to the dispensing nozzle, to dispense a dose of powder from the orifice, and means for controlling said vibrational pulses to thereby control flow of powder through the nozzle.

2. Apparatus according to claim 1, wherein the means for controlling said vibrational pulses is an electrical pulse train generator connected to the transducer, and adapted to produce a train of electrical pulses, wherein each said electrical pulse is such as to cause the transducer to dispense a predetermined quantity of the said powder.

3. Apparatus according to claim 2, wherein the electrical pulses in the electrical pulse train are substantially identical, whereby each predetermined quantity of powder is substantially equal.

4. Apparatus according to claim 1, wherein the dispensing orifice has a maximum internal horizontal dimension of 2 mm.

5. Apparatus according to claim 1, wherein the dispensing orifice has a maximum internal horizontal dimension of 1 mm.

6. Apparatus according to claim 1, wherein the walls of internal passage leading from the said upper portion to the dispensing orifice taper at an angle of from 5° to 45° to the vertical.

7. A method of dispensing a powder, comprising:
providing a supply of the powder in a nozzle according to claim 1, and
supplying a voltage to the transducer to provide a vibrational pulse train to thereby expel aliquots of the powder from the nozzle.

8. A method according to claim 7, wherein the means for controlling said vibrational pulses is an electrical pulse train generator connected to the transducer, and adapted to produce a train of electrical pulses, wherein each said electrical pulse is such as to cause the transducer to dispense a predetermined quantity of the said powder.

9. A method according to claim 8, wherein the electrical pulses in the electrical pulse train are substantially identical, whereby each predetermined quantity of powder is substantially equal.

10. A method according to claim 7, wherein the powder has a particle size of not more than 50 μm (as measured by ASTM B822-02).

11. A method according to claim 7, wherein the powder has a bulk density of not more than 2,000 kg/m³.

12. A method according to claim 7, wherein the powder has a bulk density of not more than 1,000 kg/m³.

13. A method according to claim 7, wherein the powder has an angle of repose of at least 30°.
